(19) United States
(12) Patent Application Publication
(10) Pub. No.: US 2019/0172263 A1
(43) Pub. Date: Jun. 6, 2019

(54) METHOD AND APPARATUS FOR AUGMENTING REALITY

(71) Applicant: Baidu Online Network Technology (Beijing) Co., Ltd., Beijing (CN)

(72) Inventors: Yingchao Li, Beijing (CN); Zhongqin Wu, Beijing (CN); Zuncheng Yang, Beijing (CN); Qihan Luo, Beijing (CN)

(21) Appl. No.: 16/134,602

(22) Filed: Sep. 18, 2018

(30) Foreign Application Priority Data
Nov. 15, 2017 (CN) 201711131667.5

(51) Int. Cl. G06T 19/00; G06F 17/30

(52) U.S. Cl. CPC G06T 19/006; G06F 3/04815; G06F 17/30896

(57) ABSTRACT

A method and apparatus for augmenting reality are disclosed. An embodiment of the method includes: sending an image in a page browsed by a user to a server; presenting the indication identifier to the user, in response to receiving the indication identifier sent by the server, the indication identifier indicating that the image is associated with augmented reality contents, and the indication identifier being generated based on that the image being associated with augmented reality contents is detected by the server; and acquiring, in response to detecting a preset operation of the user on the indication identifier, the augmented reality contents associated with the image, and augmenting reality using the augmented reality contents associated with the image. User may use augmented reality without installing an augmented reality application, and interactions with the user are directly performed through the augmented reality contents, which widens application scenarios of augmented reality.

### CROSS-REFERENCE TO RELATED APPLICATIONS

This application claims priority to Chinese Patent Application No. 201711131667.5, filed with the China National Intellectual Property Administration (CNIPA) on Nov. 15, 2017, the content of which is incorporated herein by reference in its entirety.

### TECHNICAL FIELD

The present disclosure relates to the field of computer, specifically to the field of augmented reality, and more specifically to a method and apparatus for augmenting reality.

### BACKGROUND

At present, to use the augmented reality functions provided by an augmented reality application, a user needs to download and install the augmented reality application. In addition, interactions with the user are lacking in the augmented reality functions, and application scenarios of the augmented reality are relatively simple.

### SUMMARY

The present disclosure provides a method and apparatus for augmenting reality.

In a first aspect, the present disclosure provides a method for augmenting reality. The method includes: sending an image in a page browsed by a user to a server; presenting, in response to receiving an indication identifier sent by the server, the indication identifier to the user, the indication identifier indicating the image being associated with augmented reality contents, and the indication identifier being generated based on that the image being associated with the augmented reality contents is detected by the server; and acquiring, in response to detecting a preset operation of the user on the indication identifier, the augmented reality contents associated with the image in the page browsed by the user, and augmenting the reality using the augmented reality contents associated with the image in the page browsed by the user.

In a second aspect, the present disclosure provides an apparatus for augmenting reality. The apparatus includes: a sending unit, configured to send an image in a page browsed by a user to a server; a first responding unit, configured to present, in response to receiving an indication identifier sent by the server, the indication identifier to the user, the indication identifier indicating the image being associated with augmented reality contents, and the indication identifier being generated based on that the image being associated with the augmented reality contents is detected by the server; and a second responding unit, configured to acquire, in response to detecting a preset operation of the user on the indication identifier, the augmented reality contents associated with the image in the page browsed by the user, and augmenting the reality using the augmented reality contents associated with the image in the page browsed by the user.

By sending an image in a page browsed by a user to a server; presenting, in response to receiving an indication identifier sent by the server, the indication identifier to the user, the indication identifier indicating the image being associated with augmented reality contents, and the indication identifier being generated based on that the image being associated with the augmented reality contents is detected by the server; acquiring, in response to detecting a preset operation of the user on the indication identifier, the augmented reality contents associated with the image, and augmenting the reality using the augmented reality contents associated with the image, the method and apparatus for augmented reality provided by the present disclosure realize The automatic detection of the image associated with the augmented reality contents in the page browsed by the user and the augmented reality by using the augmented reality contents associated with the image. On one hand, the user may use augmented reality functions without installing an augmented reality application. On the other hand, interactions with the user are directly performed through the augmented reality contents associated with the image, which widens the application scenarios of the augmented reality.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 illustrates an exemplary system architecture which may be applied in a method and apparatus for augmenting reality according to the present disclosure;

FIG. 2 is a flowchart of an embodiment of the method for augmenting reality according to the present disclosure;

FIG. 3 is a schematic structural diagram of an embodiment of the apparatus for augmenting reality according to the present disclosure; and

FIG. 4 is a schematic structural diagram of a computer system adapted to implement a terminal according to embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

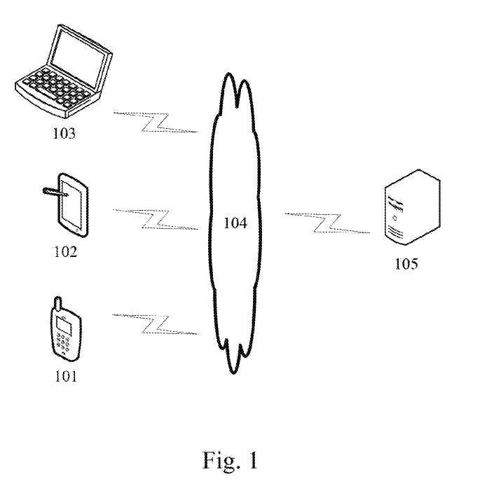

FIG. 1 shows an exemplary architecture of a method or apparatus for augmenting reality according to the embodiments of the present disclosure.

As shown in FIG. 1, the system architecture 100 may include terminals 101, 102 and 103, a network 104 and a server 105. The network 104 serves as a medium providing a communication link between the terminals 101, 102 and 103 and the server 105. The network 104 may include various types of connections, such as wired or wireless transmission links, or optical fibers.

The terminals 101, 102 and 103 may interact with the server 105 through the network 104, in order to transmit or receive messages, etc. Various communication applications, such as browser applications, APPs, search applications may be installed on the terminals 101, 102 and 103.

The terminals 101, 102 and 103 may be various terminals supporting display screen and network communication, including but not limited to, smart phones, tablet computers, e-book readers, laptop computers and desktop computers.

The server 105 may be a server that provides augmented reality services for the terminals 101, 102, and 103. The server 105 may detect whether an image in a page browsed by the user and sent by the terminals 101, 102, and 103 is associated with augmented reality contents. When the server 105 detects that the image in the page browsed by the user and sent by the terminals 101, 102, and 103 is associated with the augmented reality contents, an indication identifier indicating the augmented reality contents being associated with the image may be generated. The indication identifier is sent to the terminals 101, 102, and 103. The terminals 101, 102, and 103 may acquire the augmented reality contents associated with the image in the page browsed by the user from the server 105, and augment reality using the augmented reality contents associated with the image in the page browsed by the user.

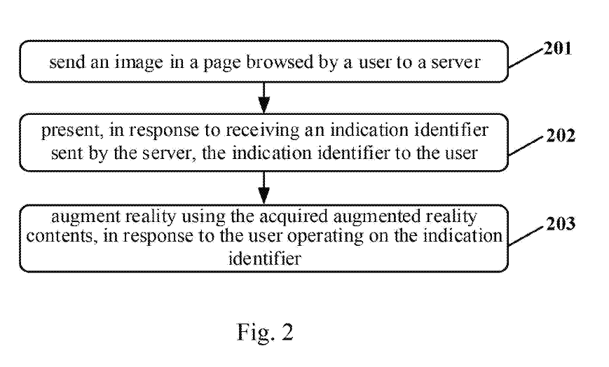

Referring to FIG. 2, which illustrates a flow of an embodiment of the method for augmenting reality according to the present disclosure. It should be noted that the method for augmenting reality provided by the embodiment of the present disclosure may be performed by a terminal (e.g., the terminals 101, 102, and 103 in FIG. 1). The method includes the following steps.

Step 201, sending an image in a page browsed by a user to a server.

In this embodiment, when an user browses a page in a terminal, whether the page browsed by the user contains an image may first be detected in the terminal. When it is detected that the page browsed by the user contains an image, the user terminal may send the image in the page browsed by the user to the server.

In this embodiment, pages browsed by the user may include, but not limited to, a webpage, or a page of a preset application. When the user browses the webpage in a browser, whether the webpage contains an image may first be detected. When the webpage contains the image, the user terminal may send the image in the webpage to the server. The preset application may be a non-augmented reality APP. When the user browses an APP page in the non-Augmented Reality APP, whether the APP page contains an image may first be detected. When it is detected that the APP page browsed by the user contains an image, the user terminal may send the image in the APP page to the server.

Step 202, presenting, in response to receiving an indication identifier sent by the server, the indication identifier to the user.

In this embodiment, after the image in the page browsed by the user is sent to the server in step 201, the server may detect whether the image in the page browsed by the user is associated with augmented reality contents. When the server detects that the image is associated with augmented reality contents, the server may generate the indication identifier indicating that the image in the page browsed by the user is associated with augmented reality contents. The server may send the indication identifier to the user terminal.

The server may pre-establish a database, and correspondingly store the image associated with augmented reality contents and the augmented reality contents into the database. One image may be associated with a plurality of augmented reality contents. After receiving the image in the page browsed by the user and sent by the user terminal, the server may detect whether the received image is in the database, and then detect whether the image in the page browsed by the user is associated with augmented reality contents. After detecting that the image is associated with augmented reality contents, the server may generate the indication identifier, and send the indication identifier to the user terminal. After the user terminal receives the indication identifier, the indication identifier may be superimposed on the image in the page browsed by the user at the user terminal.

For example, the image in the page browsed by the user is an image of an intelligent robot. Before the image in the page browsed by the user is sent to the server in step 201, the server pre-stores, in the database, the image of the intelligent robot and the augmented reality contents corresponding to the image. For example, the augmented reality contents corresponding to the image include: a three-dimensional model corresponding to the intelligent robot, which is pre-constructed through three-dimensional modeling. After receiving the image in the page browsed by the user and sent by the user terminal, the server may detect that the image is pre-stored in the database of the server, and thus, the server may detect that the image in the page browsed by the user is associated with augmented reality contents.

Step 203, augmenting, in response to the user performing a preset operation on the indication identifier, the reality using acquired augmented reality contents.

In this embodiment, after the indication identifier is presented to the user in step 202, whether the user performs the preset operation on the indication identifier may be detected. When it is detected that the user performs the preset operation on the indication identifier, the augmented reality contents associated with the image may be acquired from the server, and the reality is augmented using the augmented reality contents associated with the image.

For example, the preset operation is a click operation, and the user browses the APP page in the non-augmented reality APP running on the user terminal. When the APP page contains an image, the user terminal sends the image to the server. After detecting that the image is associated with augmented reality contents, the server generates an indication identifier, and the indication identifier may be an icon. The server may send the icon to the user terminal, and may superimpose the icon on the image at the user terminal. When the user clicks the icon, the augmented reality contents associated with the image may be acquired. Meanwhile, the user may be guided to find an image having the same contents as that of the image to capture. For example, the image in the APP page browsed by the user is an advertisement image of an advertisement, and an image on a billboard near the user is an advertisement image having the same contents as that of the image in the APP page browsed by the user. After the user is guided to capture the advertisement image, the augmented reality contents may be superimposed on the advertisement image captured by the user in an augmented reality. Then, the advertisement image superimposed with the augmented reality contents is presented to the user.

In some alternative implementations of this embodiment, the augmented reality contents associated with the image in the page browsed by the user may include, but not limited to, a model, a text, an image, or a video.

In some alternative implementations of this embodiment, when the reality is augmented using the acquired augmented reality contents associated with the image in the page browsed by the user, the camera of the user terminal browsing the image in the page may be automatically turned on. The augmented reality contents associated with the image in the page browsed by the user are superimposed onto the image collected by the camera in an augmented reality. Then, the image collected by the camera and superimposed with the augmented reality contents is presented to the user. The effect presented to the user is the same as that of superimposing the augmented reality contents into the real scenario currently viewed by the user through the camera. The augmented reality contents may contain a text to guide the user to interact.

For example, the image in the page browsed by the user is the image of an intelligent robot, and the augmented reality contents corresponding to the image include: the three-dimensional model corresponding to the intelligent robot, which is pre-constructed through the three-dimensional modeling. The indication identifier is an icon. When the user clicks the icon, the camera of the user terminal may be turned on, and the three-dimensional model corresponding to the intelligent robot is superimposed on the image collected by the camera in an augmented reality. The effect presented to the user is the same as that of superimposing the three-dimensional model corresponding to the intelligent robot into the real scenario currently viewed by the user through the camera. The three-dimensional model may contain a text such as “hello, may I help you” to guide the user to interact. The user may call an interactive program in the user terminal through a voice input, and further interaction with the user may be performed through the interactive program in the user terminal.

In some alternative implementations of this embodiment, after the reality is augmented using the augmented reality contents associated with the image, when the user performs a preset operation on the augmented reality contents, interactive contents corresponding to the augmented reality contents may be presented to the user.

For example, the preset operation is a click operation, and the image in the page browsed by the user is the image of an intelligent robot. The augmented reality contents corresponding to the image include: a three-dimensional model corresponding to the intelligent robot, which is pre-constructed through the three-dimensional modeling. The three-dimensional model corresponding to the intelligent robot is superimposed onto the image collected by the camera in an augmented reality, and the image superimposed with the three-dimensional model corresponding to the intelligent robot and collected by the camera is presented to the user. Afterwards, the user may click the three-dimensional model, and the interactive contents corresponding to the three-dimensional model may be presented to the user. For example, the interactive contents corresponding to the three-dimensional model are detailed introduction information for the three-dimensional model.

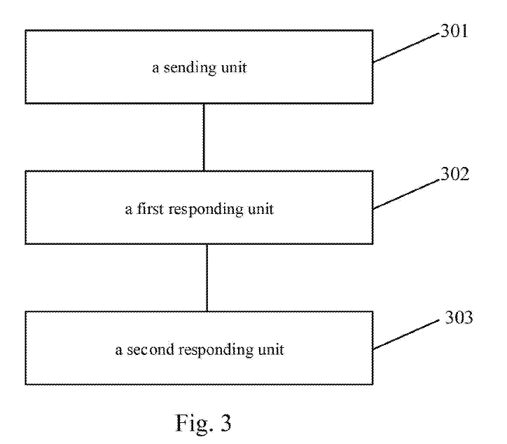

Referring to FIG. 3, as an implementation of the method shown in the above figure, the present disclosure provides an embodiment of an apparatus for augmenting reality. The embodiment of the apparatus corresponds to the embodiment of the method illustrated in FIG. 2.

As shown in FIG. 3, the apparatus for augmented reality includes: a sending unit 301, a first responding unit 302, and a second responding unit 303. The sending unit 301 is configured to send an image in a page browsed by a user to a server. The first responding unit 302 is configured to present, in response to receiving an indication identifier sent by the server, the indication identifier to the user. The indication identifier indicates that the image is associated with augmented reality contents, and the indication identifier is generated based on that the augmented reality contents being associated with the image is detected by the server. The second responding unit 303 is configured to acquire, in response to detecting a preset operation of the user on the indication identifier, the augmented reality contents associated with the image in the page browsed by the user, and augmenting the reality using the augmented reality contents associated with the image in the page browsed by the user.

In some alternative implementations of this embodiment, the second responding unit 303 includes: an image augmented reality subunit, configured to turn on a camera of a user terminal browsing the image in the page, and superimpose the augmented reality contents associated with the image in the page browsed by the user onto the image collected by the camera in an augmented reality.

In some alternative implementations of this embodiment, the apparatus for augmented reality further includes: an interacting unit, configured to present, in response to detecting a preset operation of the user on the augmented reality contents associated with the image in the page browsed by the user, interactive contents corresponding to the augmented reality contents associated with the image in the page browsed by the user to the user.

In some alternative implementations of this embodiment, the augmented reality contents associated with the image in the page browsed by the user include: a model, a text, an image, or a video.

In some alternative implementations of this embodiment, pages browsed by the user include a webpage or a page of a preset application.

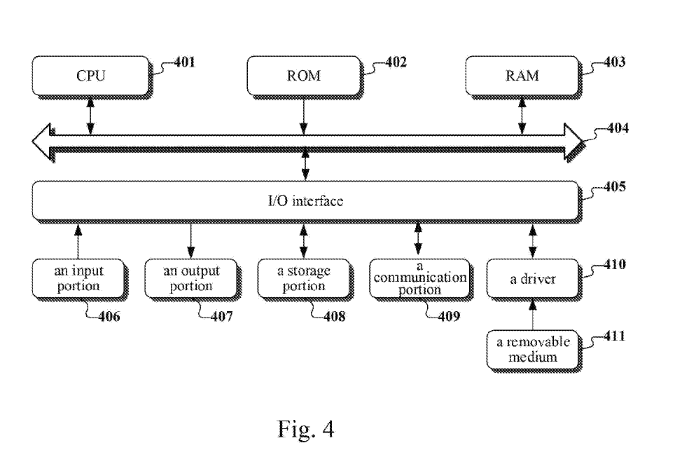

FIG. 4 illustrates a schematic structural diagram of a computer system adapted to implement the embodiments of present disclosure.

As shown in FIG. 4, the computer system includes a central processing unit (CPU) 401, which may execute various appropriate actions and processes in accordance with a program stored in a read-only memory (ROM) 402 or a program loaded into a random access memory (RAM) 403 from a storage portion 408. The RAM 403 also stores various programs and data required by operations of the system. The CPU 401, the ROM 402 and the RAM 403 are connected to each other through a bus 404. An input/output (I/O) interface 405 is also connected to the bus 404.

The following components are connected to the I/O interface 405: an input portion 406; an output portion 407; a storage portion 408 including a hard disk and the like; and a communication portion 409 comprising a network interface card, such as a LAN card and a modem. The communication portion 409 performs communication processes via a network, such as the Internet. A driver 410 is also connected to the I/O interface 405 as required. A removable medium 411, such as a magnetic disk, an optical disk, a magneto-optical disk, and a semiconductor memory, may be installed on the driver 410, to facilitate the retrieval of a computer program from the removable medium 411, and the installation thereof on the storage portion 408 as needed.

In particular, the process described in the embodiments of the present disclosure may be implemented as a computer program. For example, an embodiment of the present disclosure includes a computer program product, which comprises a computer program that is embedded in a machine-readable medium. The computer program comprises program codes for executing the method as illustrated in the flow chart. The computer program may be downloaded and installed from a network via the communication portion 409, and/or may be installed from the removable media 411. The computer program, when executed by the central processing unit (CPU) 401, implements the above mentioned functionalities as defined by the methods of the present disclosure.

The present disclosure further provides a terminal. The terminal may configured with one or more processors and a storage device. The storage device is configured to store one or more programs which comprise instructions for implementing the operations described in the above step 201-203. When the one or more programs are executed by the one or more processors, the one or more processers are caused to implement the operations described in the above steps 201-203.

The present disclosure further provides a computer-readable medium. The computer-readable medium may be the computer medium included in the apparatus, or a stand-alone computer-readable medium not assembled into the apparatus. The computer-readable medium stores one or more programs. The one or more programs, when executed by a device, cause the device to: send an image in a page browsed by a user to a server; present, in response to receiving an indication identifier sent by the server, the indication identifier to the user, the indication identifier indicating the image being associated with augmented reality contents, and the indication identifier being generated based on that the image being associated with the augmented reality contents is detected by the server; acquire, in response to detecting a preset operation of the user on the indication identifier, the augmented reality contents associated with the image, and augment the reality using the augmented reality contents associated with the image.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising a sending unit, a first responding unit and a second responding unit, where the names of these units or modules do not in some cases constitute a limitation to such units or modules themselves. For example, the sending unit may also be described as “a unit for sending an image in the page browsed by the user to the server.”

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for augmenting reality, comprising:
sending an image in a page browsed by a user to a server;
presenting, in response to receiving an indication identifier sent by the server, the indication identifier to the user, the indication identifier indicating the image being associated with augmented reality contents, and the indication identifier being generated based on that the image being associated with the augmented reality contents is detected by the server;
acquiring, in response to detecting a preset operation of the user on the indication identifier, the augmented reality contents associated with the image, and augmenting reality using the augmented reality contents associated with the image.

2. The method according to claim 1, wherein the augmenting reality using the augmented reality contents associated with the image comprises:
turning on a camera of a user terminal; and
superimposing, in an augmented reality, the augmented reality contents associated with the image onto an image collected by the camera.

3. The method according to claim 2, wherein after the augmenting reality using the augmented reality contents associated with the image, the method further comprises:
presenting, in response to detecting the preset operation of the user on the augmented reality contents associated with the image, interactive contents corresponding to the augmented reality contents associated with the image to the user.

4. The method according to claim 1, wherein types of the augmented reality contents associated with the image include: model, text, image, or video.

5. The method according to claim 1, wherein the page includes: a webpage or a page of a preset application.

6. An apparatus for augmenting reality, comprising:
at least one processor; and
a memory storing instructions, the instructions when executed by the at least one processor, cause the at least one processor to perform operations, the operations comprising:
sending an image in a page browsed by a user to a server;
presenting, in response to receiving an indication identifier sent by the server, the indication identifier to the user, the indication identifier indicating the image being associated with augmented reality contents, and the indication identifier being generated based on that the image being associated with the augmented reality contents is detected by the server; and
acquiring, in response to detecting a preset operation of the user on the indication identifier, the augmented reality contents associated with the image, and augmenting reality using the augmented reality contents associated with the image.

7. The apparatus according to claim 6, wherein the augmenting reality using the augmented reality contents associated with the image comprises:
turning on a camera of a user terminal; and superimposing, in an augmented reality, the augmented reality contents associated with the image onto an image collected by the camera.

8. The apparatus according to claim 7, wherein the operations further comprises:
presenting, in response to detecting the preset operation of the user on the augmented reality contents associated with the image, interactive contents corresponding to the augmented reality contents associated with the image to the user.

9. A non-transitory computer readable storage medium storing a computer program, wherein the computer program, when executed by a processor, cause the processor to perform operations, the operations comprising:
sending an image in a page browsed by a user to a server;
presenting, in response to receiving an indication identifier sent by the server, the indication identifier to the user, the indication identifier indicating the image being associated with augmented reality contents, and the indication identifier being generated based on that the image being associated with the augmented reality contents is detected by the server;
acquiring, in response to detecting a preset operation of the user on the indication identifier, the augmented reality contents associated with the image, and augmenting reality using the augmented reality contents associated with the image.
